(19) United States
(12) Patent Application Publication
(10) Pub. No.: US 2026/0292503 A1
(43) Pub. Date: Sep. 24, 2026

(54) SYSTEM AND METHOD FOR ACCESS TOKEN VALIDATION AT A NETWORK REPOSITORY FUNCTION

(71) Applicant: JIO PLATFORMS LIMITED, Ahmedabad (IN)

(72) Inventors: Aditya GUPTA, Kamal (IN); Mukta SHETTY, Thane (IN); Apoorva KHAMESRA, Udaipur (IN); Milankumar KALAVADIYA, Jamnagar (IN); Yugandhara JOSHI, Amravati (IN)

(73) Assignee: JIO PLATFORMS LIMITED, Ahmedabad (IN)

(21) Appl. No.: 18/873,177

(22) PCT Filed: Jun. 29, 2023
(86) PCT No.: PCT/IB2023/056776

§ 371 Date: Dec. 9, 2024

(30) Foreign Application Priority Data
Jun. 29, 2022 (IN) 202221037228

(51) Int. Cl. H04W 12/084; H04W 12/041; H04W 12/61

(52) U.S. Cl. CPC H04W 12/084; H04W 12/041; H04W 12/61

(57) ABSTRACT

The present disclosure provides a system and a method for access token validation at a network repository function (NRF). The system comprises an authorization server that receives a token from various users, decodes the token and sends a valid token to a resource server within a predetermined period. The resource server provides one or more requested services via the authorization server to the various users within the predetermined period based on the valid token. Further, variations in token generation and validation methods are updated at the system itself without any modifications at the resource server.

### RESERVATION OF RIGHTS

A portion of the disclosure of this patent document contains material, which is subject to intellectual property rights such as but are not limited to, copyright, design, trademark, integrated circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF INVENTION

The embodiments of the present disclosure generally relate to systems and methods for authorization in a network repository function. More particularly, the present disclosure relates to a system and a method for access token validation at a network repository function.

### BACKGROUND OF INVENTION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

As part of authorization of network function (NF) services access, third generation partnership project (3GPP) provides a standard authorization using an open authorization (OAUTH) token, where a network repository function (NRF) acts as an “Authorization Server,” consumers act as a “OAUTH client,” and a producer acts as an “OAUTH Resource Server.” In current systems, the consumer (OAUTH client), on receiving the token from the NRF, sends the token towards the producer (OATH Resource Server), which possesses a responsibility of validating the token. With the above setup, a key may be pre-exchanged between the Resource Server and Authorization Server for which clear flows are not standardized. Further, the key is deployment specific that further results in use of key pairs (Symmetric/Asymmetric Keys) which are generally shared between nodes via non-secure practices.

There is, therefore, a need in the art to provide a system and a method that can mitigate the problems associated with the prior arts.

### OBJECTS OF THE INVENTION

Some of the objects of the present disclosure, which at least one embodiment herein satisfies are listed herein below.

It is an object of the present disclosure to provide a system and a method where a key exchange mechanism between an authorization server and a resource server is omitted and a validation process is facilitated through an authorization server.

It is an object of the present disclosure to provide a system and a method where the authorization server is responsible for validating resources for the resource server, thereby resulting in a secure implementation.

It is an object of the present disclosure to provide a system and a method where the validation by the authorization server results in an efficient system.

It is an object of the present disclosure to provide an enhanced secured communication system.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure relates to a system for token validation at a network repository function (NRF). The system includes a processor and a memory operatively coupled to the processor, where the memory stores instructions to be executed by the processor. The processor receives a token from one or more users via a computing device. The token is based on a network function (NF) request generated by the one or more users. The processor decodes the token received from the one or more users and determines if the decoded token is valid. The processor, in response to a positive determination, sends the decoded token to a resource server within a predetermined period. The processor receives a token validation request from the resource server within the predetermined time. The processor generates one or more requested services for the one or more users via the resource server within the predetermined period.

In an embodiment, the processor may, in response to a negative determination, send a failure response to the resource server.

In an embodiment, the processor may receive a forbidden error response from the resource server upon an expiry of the predetermined period.

In an embodiment, the processor may receive an access request to the resource server from the one or more users based on the forbidden error response.

In an embodiment, the processor may send a network function instance identification (NFinstanceID) along with the decoded token to the resource server.

In an embodiment, the processor may generate a key based on the token received from the one or more users and use the key for decoding the token and processing the token validation request.

In an aspect, the present disclosure relates to a method for token validation at a NRF. The method includes receiving, by a processor associated with a system, a token from one or more users via a computing device. The token is based on a NF request generated by the one or more users. The method includes decoding, by the processor, the token received from the one or more users and determining if the decoded token is valid. The method includes, in response to a positive determination, sending by the processor, the decoded token to a resource server within a predetermined period. The method includes receiving, by the processor, a token validation request from the resource server within the predetermined period. The method includes generating, by the processor, one or more requested services for the one or more users via the resource server within the predetermined period.

In an embodiment, the method may include sending, by the processor, a failure response to the resource server in response to a negative determination.

In an embodiment, the method may include receiving, by the processor, a forbidden error response from the resource server upon an expiry of the predetermined period.

In an embodiment, the method may include receiving, by the processor, an access request to the resource server from the one or more users based on the forbidden error response.

In an embodiment, the method may include sending, by the processor, a NFinstanceID along with the decoded token to the resource server.

In an aspect, a user equipment (UE) for sending tokens includes one or more processors communicatively coupled to a processor in a system. The one or more processors are coupled with a memory, and said memory stores instructions to be executed by the one or more processors. The one or more processors transmit a token to the processor via a network. The token is based on a NF request generated by the one or more users. The processor is configured to receive the token from the UE. The processor is configured to decode the token received from the one or more users and determine if the decoded token is valid. The processor is configured to, in response to a positive determination, send the decoded token to a resource server within a predetermined period. The processor is configured to receive a token validation request from the resource server within the predetermined period. The processor is configured to generate one or more requested services for the UE via the resource server within the predetermined period.

In an aspect, a non-transitory computer readable medium includes a processor with executable instructions that cause the processor to receive a token from one or more users via a computing device. The token is based on a NF request generated by the one or more users. The processor decodes the token received from the one or more users and determines if the decoded token is valid. The processor, in response to a positive determination, sends the decoded token to a resource server within a predetermined period. The processor receives a token validation request from the resource server within the predetermined period. The processor generates one or more requested services for the one or more users via the resource server within the predetermined period.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1 illustrates an exemplary network architecture (100) for implementing a proposed system (108), in accordance with an embodiment of the present disclosure.

FIG. 2 illustrates an exemplary block diagram (200) of a proposed system (108), in accordance with an embodiment of the present disclosure.

FIG. 3 illustrates an exemplary flow diagram (300) for token validation, in accordance with an embodiment of the present disclosure.

FIG. 4 illustrates an exemplary flow diagram (400) for token validation by a network repository function (NRF), in accordance with an embodiment of the present disclosure.

FIG. 5 illustrates an exemplary computer system (500) in which or with which embodiments of the present disclosure may be implemented.

The foregoing shall be more apparent from the following more detailed description of the disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive in a manner similar to the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

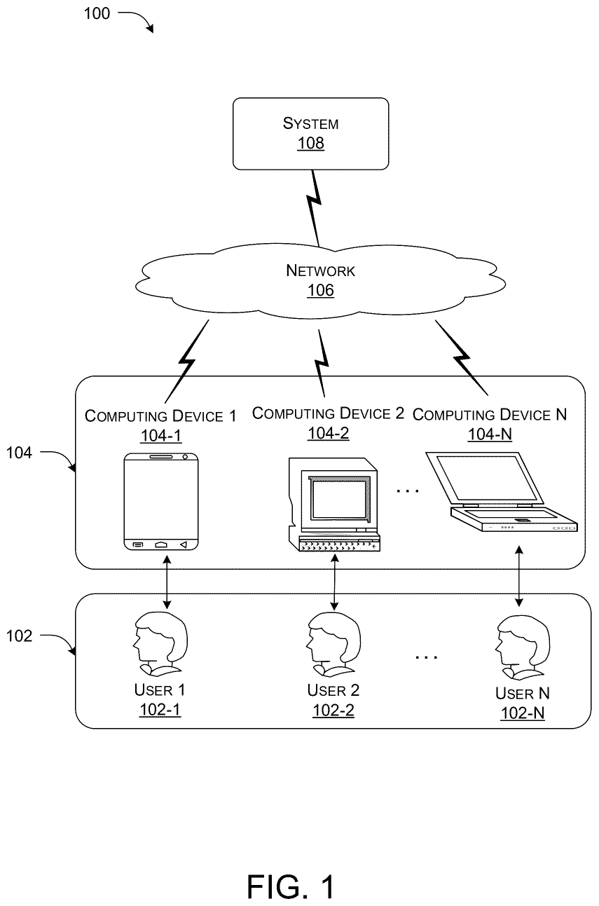

The various embodiments throughout the disclosure will be explained in more detail with reference to FIGS. 1-5.

FIG. 1 illustrates an exemplary network architecture (100) for implementing a proposed system (108), in accordance with an embodiment of the present disclosure.

As illustrated in FIG. 1, the network architecture (100) may include a system (108). The system (108) may be connected to one or more computing devices (104-1, 104-2 . . . 104-N) via a network (106). The one or more computing devices (104-1, 104-2 . . . 104-N) may be interchangeably specified as a user equipment (UE) (104) and be operated by one or more users (102-1, 102-2 . . . 102-N). Further, the one or more users (102-1, 102-2 . . . 102-N) may be interchangeably referred as a user (102) or users (102). In an embodiment, the system (108) may be interchangeably referred as an authorization server or a network resource function (NRF).

In an embodiment, the computing devices (104) may include, but not be limited to, a mobile, a laptop, etc. Further, the computing devices (104) may include a smartphone, virtual reality (VR) devices, augmented reality (AR) devices, a general-purpose computer, desktop, personal digital assistant, tablet computer, and a mainframe computer. Additionally, input devices for receiving input from the user (102) such as a touch pad, touch-enabled screen, electronic pen, and the like may be used. A person of ordinary skill in the art will appreciate that the computing devices (104) may not be restricted to the mentioned devices and various other devices may be used.

In an embodiment, the network (106) may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The network may also include, by way of example but not limitation, one or more of a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, or some combination thereof.

In an embodiment, the system (108) may receive a token from the one or more users (102) via the computing device (104). The token may be based on a network function (NF) request generated by the one or more users (102). The system (108) may decode the token received from the one or more users (102) and determine if the decoded token is valid. The system (108), in response to a positive determination, may send the decoded token to a resource server within a predetermined period. Further, the system (108) may send a network function instance identification (NFinstanceID) along with the decoded token to the resource server.

In an embodiment, the system (108) may generate a key based on the token received from the one or more users and use the key for decoding the token and processing the token validation request.

Furthermore, in an embodiment, the system (108) may receive a forbidden error response from the resource server upon an expiry of the predetermined period. The one or more users (102) may request an access to the resource server based on the forbidden error response. The resource server may also be referred as a producer or an open authorization (OAUTH) resource server.

In an embodiment, the system (108) may receive a token validation request from the resource server within the predetermined period. The system (108) may generate one or more requested services for the one or more users (102) via the resource server within the predetermined period. Further, the resource server may send a NF service response to the one or more users (102) based on a response from the processor (202).

Although FIG. 1 shows exemplary components of the network architecture (100), in other embodiments, the network architecture (100) may include fewer components, different components, differently arranged components, or additional functional components than depicted in FIG. 1. Additionally, or alternatively, one or more components of the network architecture (100) may perform functions described as being performed by one or more other components of the network architecture (100).

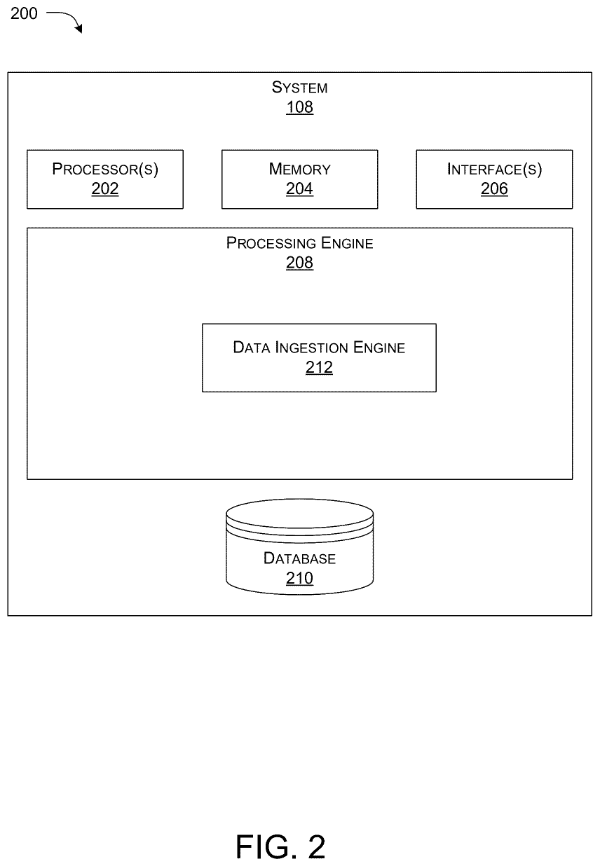

FIG. 2 illustrates an exemplary block diagram (200) of a proposed system (108), in accordance with an embodiment of the present disclosure.

Referring to FIG. 2, the system (108) may comprise one or more processor(s) (202) that may be implemented as one or more microprocessors, microcomputers, microcontrollers, digital signal processors, central processing units, logic circuitries, and/or any devices that process data based on operational instructions. Among other capabilities, the one or more processor(s) (202) may be configured to fetch and execute computer-readable instructions stored in a memory (204) of the system (108). The memory (204) may be configured to store one or more computer-readable instructions or routines in a non-transitory computer readable storage medium, which may be fetched and executed to create or share data packets over a network service. The memory (204) may comprise any non-transitory storage device including, for example, volatile memory such as random-access memory (RAM), or non-volatile memory such as erasable programmable read only memory (EPROM), flash memory, and the like.

In an embodiment, the processing engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor-executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the system (108) may comprise the machine-readable storage medium storing the instructions and the processing resource to execute the instructions, or the machine-readable storage medium may be separate but accessible to the system (108) and the processing resource. In other examples, the processing engine(s) (208) may be implemented by electronic circuitry.

In an embodiment, the system (108) may include an interface(s) (206). The interface(s) (206) may comprise a variety of interfaces, for example, interfaces for data input and output (I/O) devices, storage devices, and the like. The interface(s) (206) may also provide a communication pathway for one or more components of the system (108). Examples of such components include, but are not limited to, processing engine(s) (208) and a database (210), where the processing engine(s) (208) may include, but not be limited to, a data ingestion engine (212).

In an embodiment, the processor (202) may receive a token via the data ingestion engine (212). The token may be received from one or more users (102) via a computing device (104). The processor (202) may store the token in the database (210). The token may be based on a NF request generated by the one or more users (102). The processor (202) may decode the token received from the one or more users (102) and determine if the decoded token is valid. The processor (202), in response to a positive determination, may send the decoded token to a resource server within a predetermined period. Further, the processor (202) may send an NFinstanceID along with the decoded token to the resource server.

In an embodiment, the processor (202) may generate a key based on the token received from the one or more users and use the key for decoding the token and processing the token validation request.

Furthermore, in an embodiment, the processor (202) may receive a forbidden error response from the producer upon an expiry of the predetermined period. The one or more users (102) may request an access to the resource server based on the forbidden error response.

In an embodiment, the processor (202) may receive a token validation request from the resource server within the predetermined period. The processor (202) may generate one or more requested services for the one or more users (102) via the resource server within the predetermined period. Further, the producer may send a NF service response to the one or more users (102) based on the positive determination or a negative determination from the processor (202).

Although FIG. 2 shows exemplary components of the system (108), in other embodiments, the system (108) may include fewer components, different components, differently arranged components, or additional functional components than depicted in FIG. 2. Additionally, or alternatively, one or more components of the system (108) may perform functions described as being performed by one or more other components of the system (108).

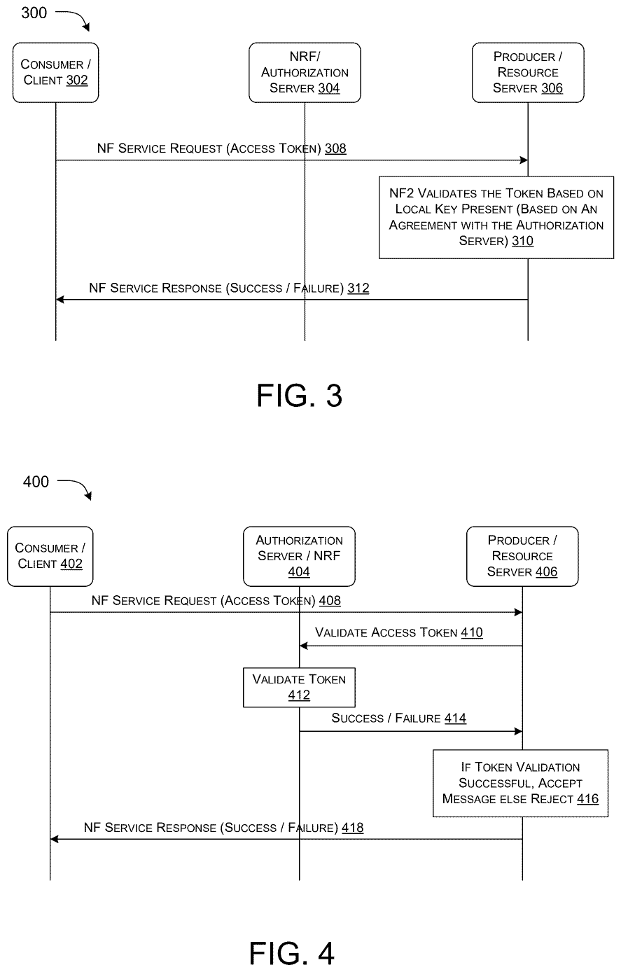

FIG. 3 illustrates an exemplary flow diagram (300) for token validation, in accordance with an embodiment of the present disclosure.

As illustrated in FIG. 3, the standard flow diagram (300) for token validation may include the following steps.

At step 308: A consumer/client (302) may send a NF service request/access token to a producer/resource server (306).

At step 310: The producer/resource server (306) may validate the NF service request based on a local key generated due to an agreement with an NRF/authorization server (304).

At step 312: The producer/resource server (306) may send a NF service response to the consumer/client (302) based on a success or failure of the agreement with the NRF/ authorization server (304).

FIG. 4 illustrates an exemplary flow diagram (400) for token validation by a NRF, in accordance with an embodiment of the present disclosure.

As illustrated in FIG. 4, the flow diagram (400) for token validation by the authorization server/NRF (404) may include the following steps.

At step 408: A consumer/client (402) may send a NF service request/access token to a producer/resource server (406). The NF service request may include an access token provided by the consumer/client (402).

At step 410: The producer/resource server (406) may send a validate access token request to the authorization server/NRF (404). The validate access token request may be based on the NF service request initiated by the consumer/client (402).

At step 412: The authorization server/NRF (404) may decode the success token and validate the access token based on the validate access token request from the producer/resource server (406)

At step 414: The authorization server/NRF (404) may send a success/failure response to the producer/resource server (406) based on the validation of the token.

At step 416: The producer/resource server (406) may accept or reject the NF service request from the consumer/client (402) based on the success/failure response from the authorization server/NRF (404).

At step 418: The producer/resource server (406) may send a NF service response to the consumer/client (402) based on the success/failure response from the authorization server/NRF (404).

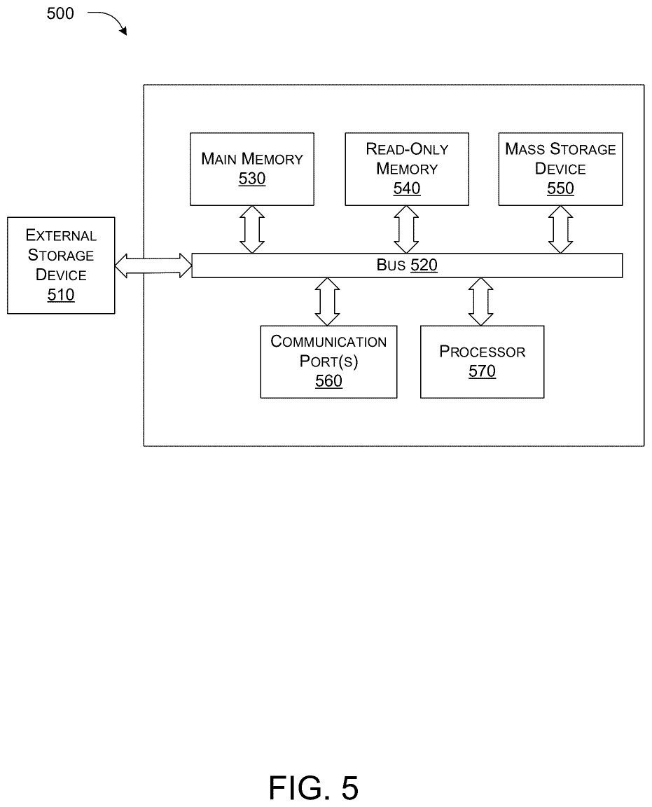

FIG. 5 illustrates an exemplary computer system (500) in which or with which embodiments of the present disclosure may be implemented.

As shown in FIG. 5, the computer system (500) may include an external storage device (510), a bus (520), a main memory (530), a read-only memory (540), a mass storage device (550), a communication port(s) (560), and a processor (570). A person skilled in the art will appreciate that the computer system (500) may include more than one processor and communication ports. The processor (570) may include various modules associated with embodiments of the present disclosure. The communication port(s) (560) may be any of an RS-232 port for use with a modem-based dialup connection, a 10/100 Ethernet port, a Gigabit or 10 Gigabit port using copper or fiber, a serial port, a parallel port, or other existing or future ports. The communication ports(s) (560) may be chosen depending on a network, such as a Local Area Network (LAN), Wide Area Network (WAN), or any network to which the computer system (500) connects.

In an embodiment, the main memory (530) may be Random Access Memory (RAM), or any other dynamic storage device commonly known in the art. The read-only memory (540) may be any static storage device(s) e.g., but not limited to, a Programmable Read Only Memory (PROM) chip for storing static information e.g., start-up or basic input/output system (BIOS) instructions for the processor (570). The mass storage device (550) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus (520) may communicatively couple the processor(s) (570) with the other memory, storage, and communication blocks. The bus (520) may be, e.g. a Peripheral Component Interconnect PCI)/PCI Extended (PCI-X) bus, Small Computer System Interface (SCSI), (USB), or the like, for connecting expansion cards, drives, and other subsystems as well as other buses, such a front side bus (FSB), which connects the processor (570) to the computer system (500).

In another embodiment, operator and administrative interfaces, e.g., a display, keyboard, and cursor control device may also be coupled to the bus (520) to support direct operator interaction with the computer system (500). Other operator and administrative interfaces can be provided through network connections connected through the communication port(s) (560). Components described above are meant only to exemplify various possibilities. In no way should the aforementioned exemplary computer system (500) limit the scope of the present disclosure.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter is to be implemented merely as illustrative of the disclosure and not as a limitation.

### ADVANTAGES OF THE INVENTION

The present disclosure provides a system and a method where a non-secure practice for key exchange is provided by a single network repository function (NRF) that incorporates both token generation and validation.

The present disclosure provides a system and a method where various methods differing from regular standards may be used to provide an additional security enhancement without altering the resource server while processing requests from various consumers.

The present disclosure provides a system and a method where changes in token generation and validation methods may be performed at an authorization server itself without any modifications in the resource server.

1. A system for token validation at a network repository function (NRF), the system comprising:
a processor; and
a memory operatively coupled with the processor, wherein said memory stores instructions which, when executed by the processor, cause the processor to:
receive a token from one or more users via a computing device, wherein the token is based on a network function (NF) request generated by the one or more users;
decode the token received from the one or more users and determine if the decoded token is valid;
in response to a positive determination, send the decoded token to a resource server within a predetermined period;
receive a token validation request from the resource server within the predetermined time; and
generate one or more requested services for the one or more users via the resource server within the predetermined period.

2. The system as claimed in claim 1, wherein the processor is to, in response to a negative determination, send a failure response to the resource server.

3. The system as claimed in claim 1, wherein the processor is to receive a forbidden error response from the resource server upon an expiry of the predetermined period.

4. The system as claimed in claim 3, wherein the processor is to receive an access request to the resource server from the one or more users based on the forbidden error response.

5. The system as claimed in claim 1, wherein the processor is to send a network function instance identification (NFinstanceID) along with the decoded token to the resource server.

6. The system as claimed in claim 1, wherein the processor is to generate a key based on the token received from the one or more users and use the key for decoding the token and processing the token validation request.

7. A method for token validation at a network repository function (NRF), the method comprising:
receiving, by a processor associated with a system, a token from one or more users via a computing device wherein the token is based on a network function (NF) request generated by the one or more users;
decoding, by the processor, the token received from the one or more users and determining if the decoded token is valid;
in response to a positive determination, sending, by the processor (202), the decoded token to a resource server within a predetermined period;
receiving, by the processor, a token validation request from the resource server within the predetermined time; and
generating, by the processor, one or more requested services for the one or more users via the resource server within the predetermined period.

8. The method as claimed in claim 7, comprising sending, by the processor, a failure response to the resource server in response to a negative determination.

9. The method as claimed in claim 7, comprising receiving, by the processor, a forbidden error response from the resource server upon an expiry of the predetermined period.

10. The method as claimed in claim 9, comprising receiving, by the processor, an access request to the resource server from the one or more users based on the forbidden error response.

11. The method as claimed in claim 7, comprising sending, by the processor, a network function instance identification (NFinstanceID) along with the decoded token to the resource server.

12. A user equipment (UE) for sending tokens, the UE comprising:
one or more processors communicatively coupled to a processor associated with a system, wherein the one or more processors are coupled with a memory, and wherein said memory stores instructions which, when executed by the one or more processors, cause the one or more processors to:
transmit a token to the processor via a network, wherein the token is based on a network function (NF) request generated by the one or more users
wherein the processor is configured to:
receive the token from the UE;
decode the token and determine if the decoded token is valid;
in response to a positive determination, send the decoded token to a resource server within a predetermined period;
receive a token validation request from the resource server within the predetermined period; and
generate one or more requested services for the UE via the resource server within the predetermined period.

13. A non-transitory computer readable medium comprising a processor with executable instructions, causing the processor to:
receive a token from one or more users via a computing device wherein the token is based on a network function (NF) request generated by the one or more users;
decode the token received from the one or more users and determine if the decoded token is valid;
in response to a positive determination, send the decoded token to a resource server within a predetermined period;
receive a token validation request within the predetermined time from the resource server; and
generate one or more requested services for the one or more users via the resource server within the predetermined period.
